(19) United States
(12) Patent Application Publication
(10) Pub. No.: US 2026/0077907 A1
(43) Pub. Date: Mar. 19, 2026

(54) STACKABLE TOTE AND METHOD THEREFOR

(71) Applicant: Symbotic LLC, Wilmington, MA (US)

(72) Inventors: Marc Ducharme, Boucherville (CA); Patrick Donaghey, Wilmington, MA (US); Christian Simon, Laval (CA)

(21) Appl. No.: 19/269,747

(22) Filed: Jul. 15, 2025

Related U.S. Application Data
(60) Provisional application No. 63/672,055, filed on Jul. 16, 2024.

(51) Int. Cl. B65D 21/02; B65D 1/26; B65D 43/02; B65D 81/26; B65G 1/137

(52) U.S. Cl. CPC B65D 21/0213; B65D 1/26; B65D 43/0218; B65D 81/261; B65G 1/1373; B65G 2201/0235

(57) ABSTRACT

A stackable tote for an automated storage and retrieval system. The stackable tote includes a tote casement of a general frustum shape with walls forming a void within the tote casement. A top of the tote casement surrounding the void has an upper rim, bounding an opening of the void, the upper rim having a flat surface for contacting and supporting another tote received by automation. A relief channel is formed in the upper rim forming an escapement space for an end of arm tool of a robot automatically stacking the other tote with the stackable tote to form a stack with a standard height on a standard pallet.

### CROSS-REFERENCE TO RELATED APPLICATIONS

This application is a non-provisional of and claim the benefit of United States provisional patent application number 63/672,055 filed on Jul. 16, 2024, the disclosure of which is incorporated herein by reference in its entirety.

### BACKGROUND

### 1. Field

The present disclosure generally relates to automated storage and retrieval systems, and more particularly, to transport of items within and from the automated storage and retrieval system.

### 2. Brief Description of Related Developments

Goods are generally transported within and from automated storage and retrieval systems, such as of a warehouse or distribution facility, in containers. The containers generally include boxes, trays, and totes. On output from the storage and retrieval system, the containers are stacked on pallets for shipping manually or in some cases with palletizing automation. The palletizing automation may be configured to pick individual containers using a fork type gripper that lifts the container, at least partially, from underneath. The palletizing automation stacks the containers one on top of the other, where a flat planar (e.g., bottom) surface of superior containers are seated on a flat planar (e.g., top) surface of an inferior container. In stacking these containers one on the other, the superior container at least partially dropped onto the inferior container. In the case of stacking totes one on the other, especially open topped or unlidded totes, the superior totes tend to fall into the inferior tote on which they are stacked which may create an unstable stack and/or damage goods held within the inferior tote.

Accordingly, the present disclosure addresses a number of those issues.

### BRIEF DESCRIPTION OF THE DRAWINGS

The foregoing aspects and other features of the present disclosure are explained in the following description, taken in connection with the accompanying drawings, wherein:

FIG. 1 is a schematic block diagram of a distribution facility in accordance with the present disclosure;

FIG. 2A is an exemplary schematic illustration of a pallet load output by the distribution facility of FIG. 1 in accordance with the present disclosure;

FIG. 2B is an exemplary cross-sectional illustration of stacked containers of the pallet load of FIGS. 2A, 7A, and 7B where the containers are nested one within another in accordance with the present disclosure;

FIG. 2C is an exemplary cross-sectional illustration of stacked lidded containers of the pallet load of FIGS. 2A, 7A, and 7B where the lidded containers are nested one within another in accordance with the present disclosure;

FIG. 2D is an exemplary cross-sectional illustration of a lidded container of the pallet load of FIGS. 2A, 7A and 7B in accordance with the present disclosure;

FIG. 2E is an exemplary cross-sectional illustration of a lidded container of the pallet load of FIGS. 2A, 7A and 7B in accordance with the present disclosure;

FIG. 3A is schematic illustration of a side of a container in accordance with the present disclosure;

FIG. 3B is a schematic illustration of another side of the container of FIG. 3A in accordance with the present disclosure;

FIG. 3C is a schematic cross-section illustration of the side of the container of FIG. 3A in accordance with the present disclosure;

FIG. 3D is a schematic perspective illustration of the container of FIG. 3A in accordance with the present disclosure;

FIG. 3E is a schematic perspective illustration of the container of FIG. 3A in accordance with the present disclosure;

FIGS. 4A-4D is an illustrative sequence of container stacking with automation where the containers are placed so as to be nested one within another in accordance with the present disclosure;

FIG. 5 is a block diagram of an exemplary method in accordance with the present disclosure;

FIG. 6 is an exemplary side illustration of the container of FIG. 3A in accordance with the present disclosure;

FIG. 7A is an exemplary schematic illustration of a pallet load output by the distribution facility of FIG. 1 in accordance with the present disclosure; and

FIG. 7B is an exemplary schematic illustration of a pallet load output by the distribution facility of FIG. 1 in accordance with the present disclosure.

### DETAILED DESCRIPTION

The following detailed description is meant to assist the understanding of one skilled in the art, and is not intended in any way to unduly limit claims connected or related to the present disclosure.

The following detailed description references various figures, where like reference numbers refer to like components and features across various figures, whether specific figures are referenced, or not.

The word “each” as used herein refers to a single object (i.e., the object) in the case of a single object or each object in the case of multiple objects. The words “a,” “an,” and “the” as used herein are inclusive of “at least one” and “one or more” so as not to limit the object being referred to as being in its “singular” form.

Spatial terms such as “left,” “right,” “top,” “bottom,” “upper,” “lower,” “front,” “back,” “vertical,” and “horizontal” as may be used herein are by way of example and illustration only are not meant to limit the description and may be exchanged in position and orientation.

The terms “substantially” and “about” as may be used herein refer to a feature that may be varied within an acceptable manufacturing tolerance for a given application.

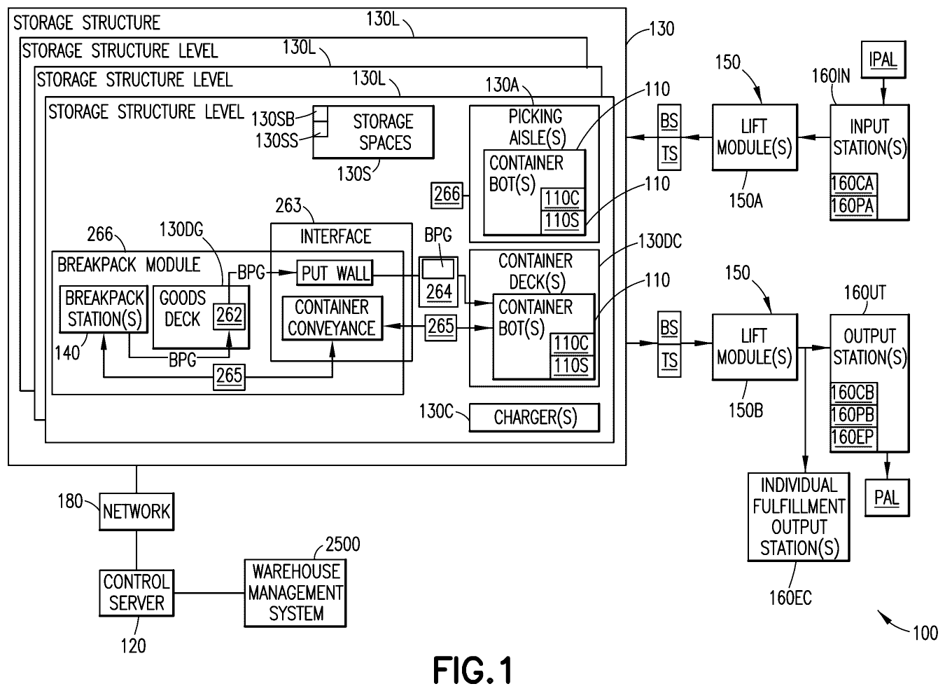

FIG. 1 is a schematic illustration of an automated storage and retrieval system (also referred to herein as a warehousing/warehouse system or product order fulfillment system) 100 in accordance with the present disclosure. Although the present disclosure will be described with reference to the drawings, it should be understood that the present disclosure can be embodied in many forms. In addition, any suitable size, shape or type of elements or materials could be used.

In accordance with the present disclosure the automated storage and retrieval system 100 may operate in a retail distribution center or warehouse to, for example, fulfill orders received from retail stores for case units such as those described in U.S. Pat. No. 10,822,168 issued on Nov. 3, 2020, the disclosure of which is incorporated by reference herein in its entirety. For example, the case units are cases or units of goods not stored in trays, on totes or on pallets (e.g. uncontained). In other examples, the case units are cases or units of goods that are contained in any suitable manner such as in trays, on totes, in containers (such as containers of remainder goods after breakpack where the broken down case unit structure is unsuitable for transport of the remainder goods as a unit) or on pallets. In still other examples, the case units are a combination of uncontained and contained items. It is noted that the case units, for example, include cased units of goods (e.g. case of soup cans, boxes of cereal, etc.) or individual goods that are adapted to be taken off of or placed on a pallet. Shipping cases for case units (e.g. cartons, barrels, boxes, crates, jugs, or any other suitable device for holding case units) may have variable sizes and may be used to hold case units in shipping and may be configured so they are capable of being palletized for shipping. It is noted that when, for example, bundles or pallets of case units arrive at the storage and retrieval system the content of each pallet may be uniform (e.g. each pallet holds a predetermined number of the same item-one pallet holds soup and another pallet holds cereal) and as pallets leave the storage and retrieval system the pallets may contain any suitable number and combination of different case units (e.g. a mixed pallet where each mixed pallet holds different types of case units-a pallet holds a combination of soup and cereal) that are provided to, for example the palletizer in a sorted arrangement for forming the mixed pallet. The storage and retrieval system 100 described herein may be applied to any environment in which case units are stored and retrieved.

In accordance with the present disclosure, orders for filled items (e.g., the pallets, cases, containers, package of goods, individual (unpacked) goods, etc.) may be stochastic (e.g., substantially random in the items ordered and a time the order is received) and may be fulfilled by the automated storage and retrieval system 100 as function of time (e.g., sortation of ordered goods at a predetermined scheduled time in advance of a time the order is to ship/be fulfilled or in a sortation of goods in a just-in-time manner). These stochastic orders are determinative of a pick sequence of sorted items, such as for building a pallet load or pallet PAL (see, e.g., U.S. Pat. No. 8,965,559 titled “Pallet Building System” and issued on Feb. 24, 2015, the disclosure of which is incorporated herein by reference in its entirety). The pallet PAL may include mixed cases, mixed totes, mixed packs, mixed units (or eaches) per tote, etc. The sorted items are picked from a common storage array (e.g., a storage array formed by storage spaces 130S of storage structure 130). The automated storage and retrieval system 100 effects a maximum throughput of goods for each order (e.g., received for processing by the automated storage and retrieval system 100) by employing or otherwise processing the order through one or more orthogonal sortation echelons (such as described in, for example, U.S patent application number Ser. No. 17/358,383 filed on Jun. 25, 2021 and titled “Warehousing System for Storing and Retrieving Goods in Containers,” the disclosure of which is incorporated herein by reference in its entirety) to a sortation level needed (e.g., e.g., the controller 120 drills/drives down through the orthogonal sortation echelons to effect the desired level of sortation needed for a given order—a case level sortation, a pack level sortation, a unit/each level sortation or a combination thereof) to effect a given order from the common storage array independent of order type (e.g., a pallet order, a case order, a pack order, mixed orders, etc.), independent of order sequence, and independent of order time.

The automated storage and retrieval system 100 includes one or more breakpack modules 266. Exemplary breakpack modules 266 suitable for employment with the present disclosure include those described in Patent Cooperation Treaty application number PCT/US24/19932 filed on Mar. 14, 2024 and titled “Warehousing System for Storing and Retrieving Goods in Containers” with attorney docket number 1127P015998-WO (EQV) and U.S. patent application number Ser. No. 18/605,294 filed Mar. 14, 2024 and titled “Warehousing System for Storing and Retrieving Goods in Containers” with attorney docket number 1127P016004-US (PAR), and those described in U.S. patent application numbers Ser. No. 17/358,383 filed Jun. 25, 2021, Ser. No. 17/657,705 filed Apr. 1, 2022, and Ser. No. 18/323,758 filed May 25, 2023, the disclosures of which are incorporated herein by reference in their entireties. The breakpack module(s) 266 is/are configured to break down product or supply containers 265 (also referred to as case units) into breakpack goods containers 264 (also referred to herein as goods containers or totes for shipping goods) for order fulfillment. Product is placed into the breakpack goods containers 264 with automation (such as a goods bot 262 as described herein) such that the products are loosely placed. The breakpack goods containers 264 are automatically stacked on pallets PAL, as described herein, for shipping from the automated storage and retrieval system 100.

The automated storage and retrieval system 100 may include (in addition to or in lieu of the breakpack modules 266) one or more each pick modules substantially similar to those described in U.S. Pat. No. 9,037,286 issued on May 19, 2015 (the disclosure of which is incorporated herein by reference), where the breakpack goods containers 264 are filled by human or robotic operators and output for transport by at least one autonomous container transport vehicle 110 (also referred to herein as “container bots” or “autonomous guided vehicles” and which form at least a part of an asynchronous transport system for level transport as described herein) for placement in storage or for transfer to an output station 160UT.

A controller 120 of the automated storage and retrieval system 100 is configured to effect operation of a container bot 110 and a goods bot 262 for assembling orders of breakpack goods BPG from supply containers 265 into breakpack goods containers 264 and outfeed of breakpack goods containers 264 through container output/transfer stations TS. For example, the controller 120 may be configured to effect, through any suitable network 180 and in accordance with warehouse management system 2500 instruction, operation of the container bot(s) 110 between the container storage locations 130S, a breakpack operation station 140 (of a breakpack module 266), and a breakpack goods container 264 located at a goods interface 263 along a breakpack goods transfer deck 130DG. The goods interface 263 may include a container conveyance that transports supply containers 265 placed on the container conveyance by the container bot 110 to the breakpack operation station 140 where breakpack goods BPG are picked from the supply container 265 and placed into a breakpack goods container 264 by a human or automated operator. The controller 120 may be configured to effect operation of the goods bot(s) 262 so that transport of the breakpack goods BPG by the goods bot 262 traversing the goods transfer deck 130DG, sorts the breakpack goods BPG, e.g., in a unit/each level sortation, to corresponding breakpack goods containers 264. The controller 120 may be configured to effect operation of the container bot(s) 110 (e.g., traversing a container transfer deck 130DC) so that the container bot(s) 110 accesses corresponding breakpack goods containers 264 at the goods transfer deck 130DG, such as from a put wall where an array of breakpack goods containers 264 are disposed, and transports the breakpack goods containers 264 via traverse along the container transfer deck 130DC to at least one of a container output/transfer station TS, a buffer station BS, and/or a corresponding container storage location 130SB of the storage spaces 130S (formed by storage shelves 130SS) of a corresponding level 130L of a multilevel storage array (i.e., storage structure 130). The buffer stations BS may be disposed at any suitable location within a respective storage structure level 130L such as within a picking aisle 130A, along the container deck 130DC, and/or provided with or adjacent the container output/transfer station TS to facilitate container transfer between the container bot(s) 110 and lift modules 150A, 150B.

It is noted that when, for example, incoming bundles or pallets (also referred to as pallet loads) IPAL (e.g. from manufacturers or suppliers of case units) arrive at the storage and retrieval system 100 for replenishment of the automated storage and retrieval system 100, the content of each pallet IPAL may be uniform (e.g. each pallet holds a predetermined number of the same item-one pallet holds soup and another pallet holds cereal). The cases or containers of such pallet IPAL may be substantially similar or in other words, homogenous cases (e.g. similar dimensions), and may have the same SKU (otherwise, as noted before the pallets may be “rainbow” pallets having layers formed of homogeneous containers). As pallets PAL leave the storage and retrieval system 100, with containers, such as the breakpack goods containers 264, filling customer replenishment orders, the pallets PAL may contain any suitable number and combination of different containers (e.g., uncontained goods/case units, goods on trays, in totes, and/or in other suitable containers) and/or breakpack goods BPG (e.g., each pallet may hold different types of case units and/or breakpack goods in containers—a pallet holds a combination of canned soup, cereal, beverage packs, cosmetics and household cleaners).

The storage and retrieval system 100 may be configured to generally include an in-feed section, a storage and sortation section (where storage of items is optional), and an output section. The storage and retrieval system 100 operating for example as a retail distribution center may serve to receive uniform pallet loads IPAL of cases, breakdown the pallet goods or disassociate the cases (e.g., at input station 160IN) from the uniform pallet loads into independent case units or supply containers 265 handled individually by the system 100, retrieve and sort the different supply containers 265 sought by each order into corresponding groups, and transport and assemble the corresponding groups of supply containers 265 and/or breakpack goods BPG in breakpack goods containers 264 (e.g., at the output station 160UT) into what may be referred to as mixed case pallet loads (see pallet load PAL noted above). The system 100 operating, for example, as a retail distribution center may serve to receive uniform pallet loads IPAL of cases, breakdown the pallet goods or disassociate the cases from the uniform pallet loads (e.g., at the input station 160IN) into independent supply containers 265 handled individually by the system, retrieve and sort the different containers sought by each order into corresponding groups, and transport and sequence the corresponding groups of containers in the manner described in U.S. Pat. No. 9,856,083 issued on Jan. 2, 2018, the disclosure of which is incorporated herein by reference in its entirety.

The storage and sortation section includes a multilevel automated storage system that has an automated transport system that in turn receives or feeds individual supply containers 265 into the multilevel storage array for storage in a storage area (such as storage spaces 130S of the storage structure 130). The storage and sortation section also defines outbound transport of containers from the multilevel storage array such that desired case units are individually retrieved in accordance with commands generated in accordance to orders entered into a warehouse management system, such as warehouse management system 2500, for transport to the output section.

The storage and sortation section may receive individual supply containers 265 and/or breakpack goods containers 264, sort the individual containers (utilizing, for example, container buffer stations BS and container output/transfer stations TS described herein), e.g., in a container level sortation, and transfer the individual containers to the output section in accordance to orders entered into the warehouse management system. The sorting and grouping of containers according to order (e.g. an order out sequence) may be performed in whole or in part by either the storage and retrieval section or the output section, or both, the boundary between being one of convenience for the description and the sorting and grouping being capable of being performed any number of ways. The intended result is that the output section assembles the appropriate group of ordered cases, that may be different in SKU, dimensions, etc. into mixed case pallet loads in the manner described in, for example, U.S. Pat. No. 8,965,559 issued on Feb. 24, 2015 and titled “Pallet Building System,” the disclosure of which is incorporated herein by reference in its entirety.

In the present disclosure, the output section generates a pallet load LPAL in what may be referred to as a structured architecture of mixed container stacks. The structured architecture of the pallet load described herein is representative however; the pallet load may have any other suitable configuration. For example, the structured architecture may be any suitable predetermined configuration such as a truck bay load or other suitable container or load container envelope holding a structural load.

Still referring to FIG. 1, the automated storage and retrieval system 100 includes a storage array (e.g., storage structure 130 with storage shelves 130SS forming or otherwise having storage spaces 130S) with at least one elevated storage level 130L (where more than one elevated storage levels forms storage racks of stacked storage levels). Mixed product units are input and distributed in the storage array in supply containers 265 of product units of common kind per container (each container input to the system 100 holds a common kind of stock keeping unit (SKU)). For example, the automated storage and retrieval system 100 includes input stations 160IN (which include depalletizers 160PA and/or conveyors 160CA for transporting items (e.g., inbound supply containers 265) to lift modules (or lifts) 150A for entry into a storage level 130L of the storage structure 130).

The automated storage and retrieval system 100 includes an automated transport system (e.g., bots, breakpack stations, and other suitable level transports described herein) with at least one asynchronous transport system for transporting cases/products on a given storage structure level 130L (e.g., level transport). The storage and retrieval system 100 includes undeterministic container bots 110 that travel along one or more physical pathways of the storage and retrieval system (e.g., such as one or more of the picking aisles 130A and container transfer deck 130DC) to provide at least one level of asynchronicity. The container bots 110 may be any suitable independently operable autonomous transport vehicles that carry and transfer containers along X and Y (planar) throughput axes throughout the storage and retrieval system 100. The container bots 110 may be automated, independent (e.g. free riding) autonomous transport vehicles. Suitable examples of container bots can be found in, for exemplary purposes only, U.S. Pat. No. 10,822,168 issued on Nov. 3, 2020; U.S. Pat. No. 8,425,173 issued on Apr. 23, 2013; U.S. Pat. No. 9,561,905 issued on Feb. 7, 2017; U.S. Pat. No. 8,965,619 issued on Feb. 24, 2015; U.S. Pat. No. 8,696,010 issued on Apr. 15, 2014; U.S. Pat. No. 9,187,244 issued on Nov. 17, 2015; U.S. Pat. No. 11,078,017 issued on Aug. 3, 2021; U.S. Pat. No. 9,499,338 issued on Nov. 22, 2016; U.S. Pat. No. 10,894,663 issued on Jan. 19, 2021; and U.S. Pat. No. 9,850,079 issued on Dec. 26, 2017, the disclosures of which are incorporated by reference herein in their entireties. The container bots 110 may be configured to place containers, such as the above described retail merchandise, into picking stock in the one or more levels of the storage structure 130 and then selectively retrieve ordered containers.

At least another level of asynchronicity is provided such that, for example, container/product holding locations are greater than the number of bots transporting containers/products. At least one lift module (or lift) 150B is provided for transporting containers/products between storage levels 130L (e.g., between level transport). The at least one lift 150B is communicably connected to the storage array (e.g., formed by the storage spaces 130S of the storage level(s) 130L) so as to automatically retrieve and output, from the storage array, product units distributed in the containers in a common part (e.g., the storage locations 130S of a respective storage level 130L) of the at least one elevated storage level 130L of the storage array. The output product units being one or more of mixed singulated product units, in mixed packed groups, and in mixed containers. As an example, the automated storage and retrieval system 100 includes output stations 160UT, 160EC (which include palletizers 160PB, operator stations 160EP and/or conveyors 160CB for transporting items (e.g., outbound supply containers 265 and filled breakpack goods (order) containers 264) from lift modules 150B for removal from storage (e.g., to a palletizer (for palletizer load) or to a truck (for truck load)). The output station 160EC may be an individual fulfillment (or e-commerce) output station where, for example, filled breakpack goods (order) containers 264 including single goods items and/or small bunches of goods are transported for fulfilling an individual fulfillment order (such as an order placed over the Internet by a consumer). The output station 160UT may be a commercial output station where large numbers of goods are generally provided on pallets for fulfilling orders from commercial entities (e.g., commercial stores, warehouse clubs, restaurants, etc.). The automated storage and retrieval system 100 may include both the commercial output station 160UT and the individual fulfillment output station 160EC although, the automated storage and retrieval system may include one or more of the commercial output station 160UT and the individual fulfillment output station 160EC.

The automated storage and retrieval system 100 also includes input and output vertical lift modules 150A, 150B (generally referred to as lift modules 150-it is noted that while input and output lift modules are shown, a single lift module may be used to both input and remove case units from the storage structure), a storage structure 130 (which may have at least one elevated storage level as noted above and may form a multilevel storage array), and at least one container bot 110 which may be confined to a respective storage level of the storage structure 130 and are distinct from a transfer deck 130DC on which they travel. It is noted that the depalletizers 160PA may be configured to remove case units from pallets so that the input station 160IN can transport the items to the lift modules 150 for input into the storage structure 130. The palletizers 160PB may be configured to place items removed from the storage structure 130 on pallets PAL for shipping. As used herein the lift modules 150, storage structure 130 and container bots 110 may be collectively referred to herein as the multilevel automated storage system (e.g. storage and sorting section) noted above, which has an integral “on the fly sortation” (e.g. sortation of case units during transport of the case units) so that case unit sorting and throughput occurs substantially simultaneously without dedicated sorters as described in U.S. Pat. No. 9,856,083 , previously incorporated herein by reference in its entirety.

The lifts 150 may be connected via transfer stations TS (also referred to herein as container infeed stations when the lift 150 is an inbound lift 150A or as container outfeed stations when the lift 150 is an outbound lift 150B) to the container transfer deck 130DC, and each lift is configured to lift one or both of supply containers 265 (empty or filled) and the breakpack goods containers 264 (empty or filled) into and out of the at least one elevated storage level 130L of the storage structure 130. Container storage locations (or spaces) 130S are arrayed peripherally along the container transfer deck 130DC and/or picking aisles 130A such as described in U.S. Pat. No. 9,856,083 , previously incorporated by reference herein in its entirety and U.S. Pat. No. 10,822,168 issued on Nov. 3, 2020, the disclosure of which is incorporated herein by reference in its entirety.

The container transfer decks 130DC are substantially open and configured for the undeterministic (i.e., not physically constrained) traversal of container bots 110 along multiple travel lanes across and along the container transfer decks 130DC. As described in U.S. Pat. No. 10,556,743 issued on Feb. 11, 2020 and having application number Ser. No. 15/671,591 (the disclosure of which is incorporated herein by reference in its entirety) the multiple travel lanes may be configured to provide multiple access paths or routes to each storage location 130S (e.g., pickface, case unit, container, or other items stored on the storage shelves) so that container bots 110 may reach each storage location using, for example, a secondary path if a primary path to the storage location is obstructed. The container transfer deck(s) 130DC at each storage level 130L communicate with each of the picking aisles 130A on the respective storage level 130L.

Still referring again to FIG. 1, each storage level 130L may also include charging stations 130C for charging an on-board power supply of the container bots 110 on that storage level 130L such as described in, for example, United States patent application number Ser. No. 14/209,086 filed on Mar. 13, 2014 and U.S. Pat. No. 9,082,112 issued on Jul. 14, 2015, the disclosures of which are incorporated herein by reference in their entireties.

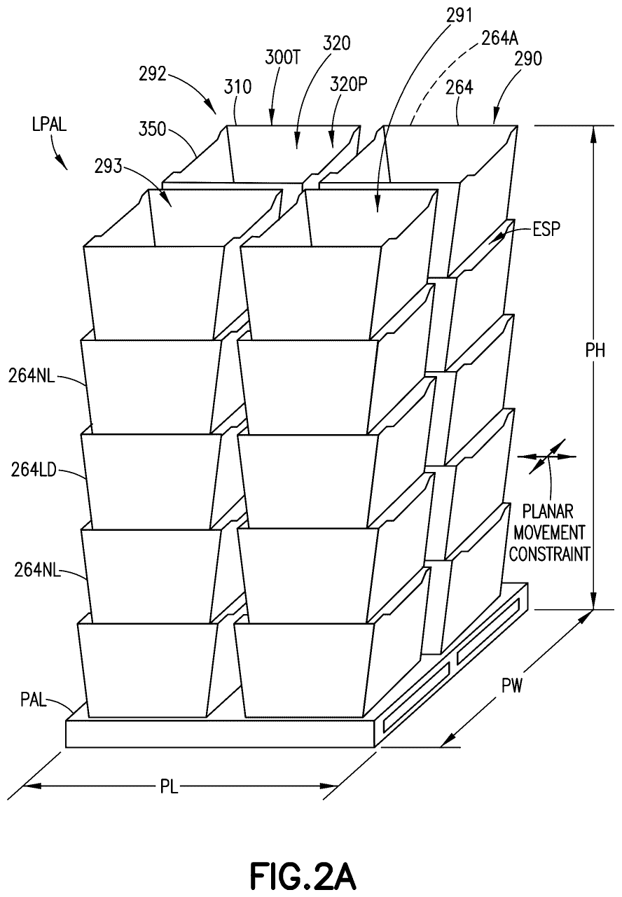

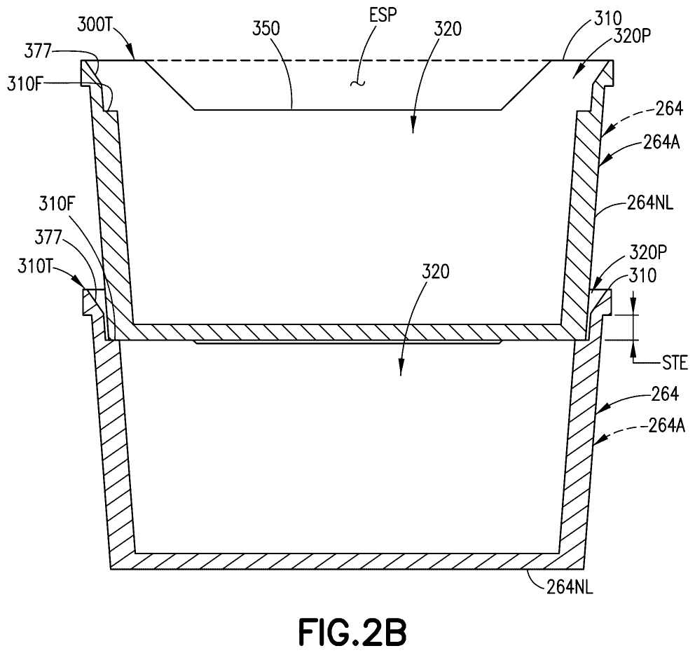

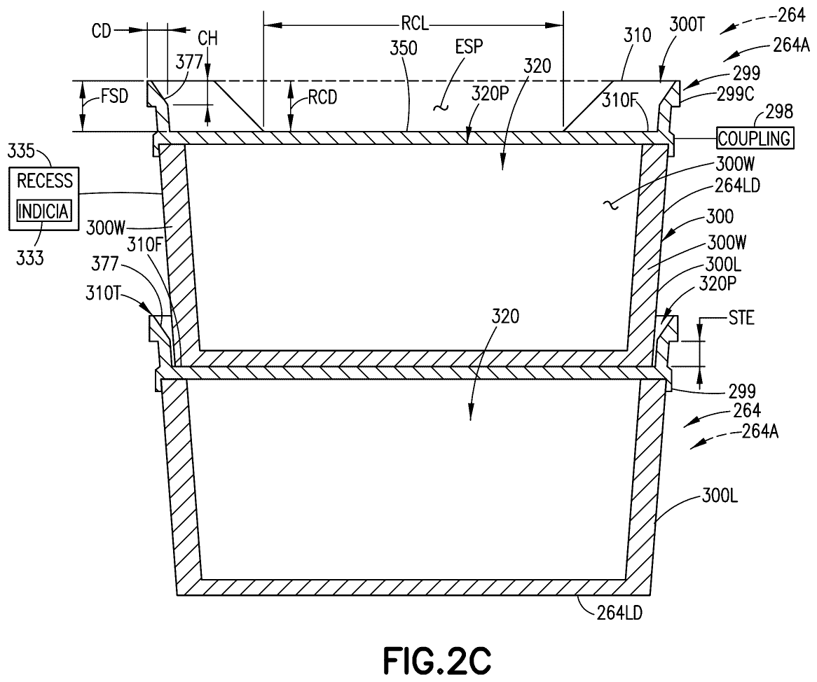

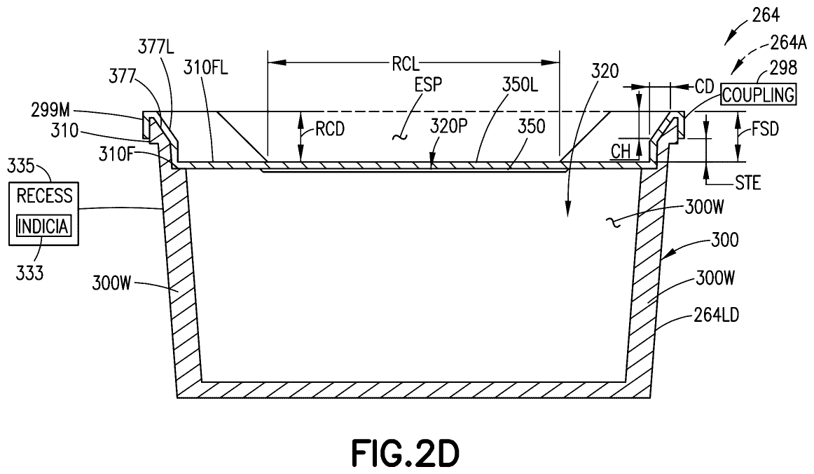

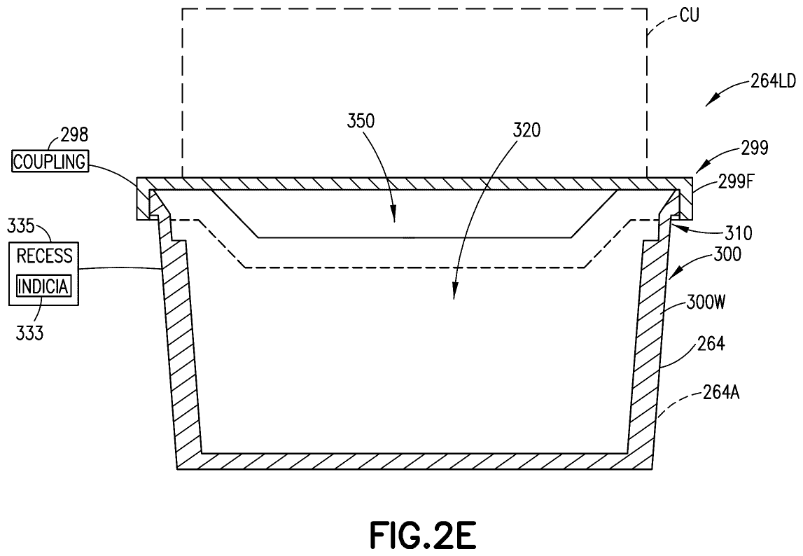

Referring to FIG. 2A, the breakpack goods containers 264 (also referred to as stackable totes) may be stacked with a standard height PH of a standard pallet PAL to form the pallet load LPAL. The standard pallet PAL has a width PW and length PL that are standardized in the shipping industry and include pallets having dimensions (width (in) × length (in)) of about: 40×48, 42×42, 48×48, 48×40, 48×42, 40×40, 48×45, 44×44, 36×36, 48×36, 35×45.5, 48×20, and 42×31 in North America; pallets having dimensions (width (mm) × length (mm)) of about: 800×1200, 1200×1000, 1000×1200, 800×600, 600×400, and 400×300 in Europe and the United Kingdom; and those pallet sizes specified in the International Organization for Standardization (ISO) standard 6780. Standard heights PH of the standard pallet PAL are about 60 inches, about 70 inches, about 80 inches, and about 102 inches although a height of the pallet may be less than about 60 inches or more than about 102 inches.

For exemplary purposes only, FIG. 2A illustrates four stacks 290-293 of breakpack goods containers 264 (twenty containers in total) on a standard pallet PAL having a width PW of about 48 inches and a length PL of about 40 inches with no overhang of the breakpack goods containers 264 beyond the edges of the pallet PAL. The standard pallet height PH of the pallet load LPAL illustrated in FIG. 2A is, for exemplary purposes, the standard height of about 70 inches. While twenty breakpack goods containers 264 are illustrated in four stacks on the pallet PAL in FIG. 2A, any suitable number of stacks of breakpack goods containers may be disposed on a standard pallet PAL such as those standard pallets identified above with a standard pallet height such as those standard heights PH identified above. Referring also to FIGS. 7A and 7B, the breakpack goods containers 264 may be stacked with other suitable shipping containers CU such as cartons, corrugated boxes, etc. For example, FIG. 7A illustrates a stack 700 of breakpack goods containers 264, 264A disposed on a pallet PAL with stacks 701, 702, 703 of the other suitable shipping containers CU, where the stacks 701, 702, 703 of other shipping containers CU may include shipping containers CU of varying sizes in each stack, such as within one or more layers in the stack. FIG. 7B illustrates breakpack goods containers 264, 264A disposed on top of the other suitable shipping containers CU in a stack 706, 707 on the pallet PAL with other stacks 704, 705 of the other suitable shipping containers CU. FIG. 7B also illustrates a suitable shipping container CU stacked on a breakpack goods container 264, 264A (such as lidded container 264LD). The breakpack goods containers 264, 264A may be placed on a pallet with the other suitable shipping containers CU in any suitable arrangement.

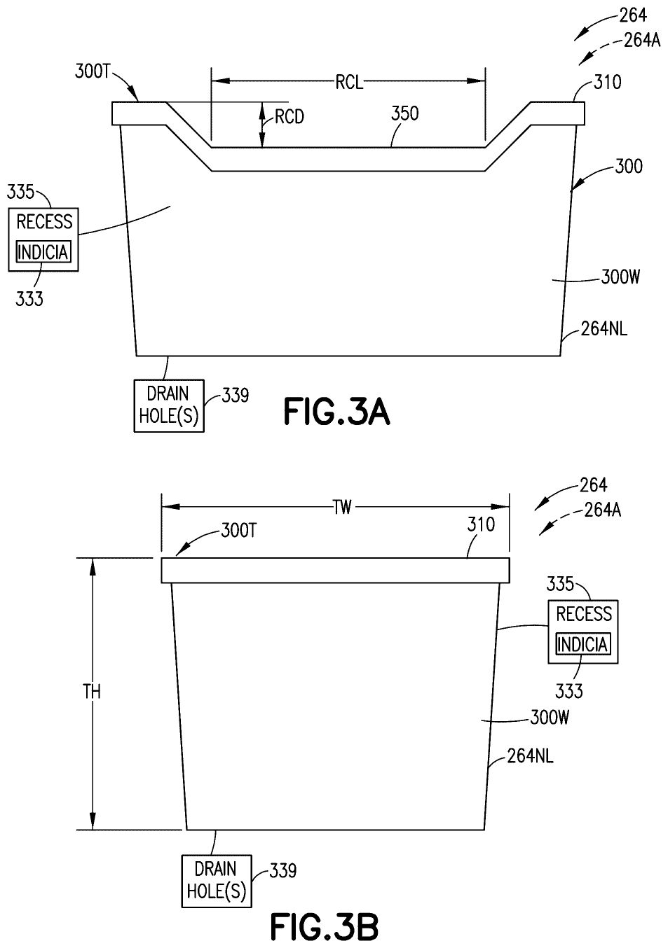

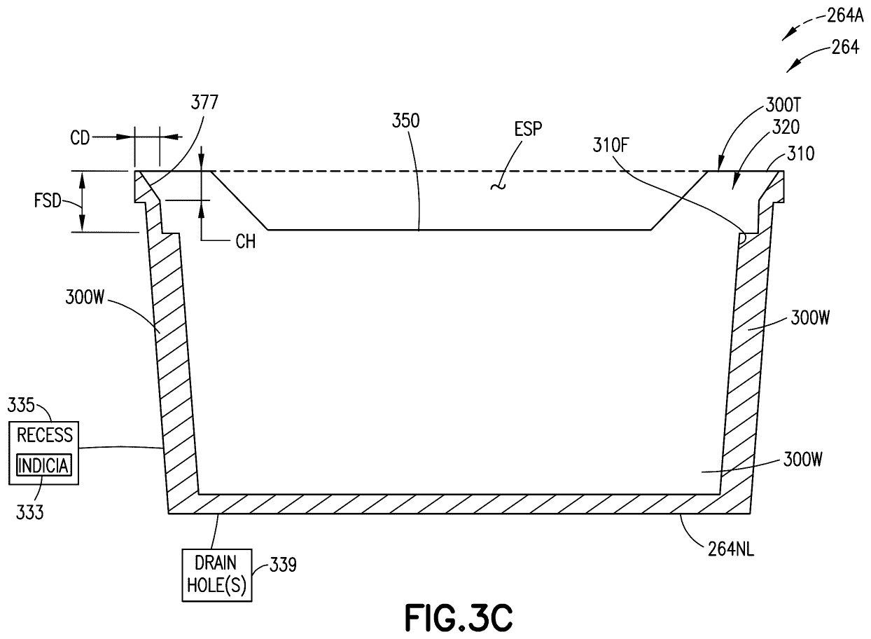

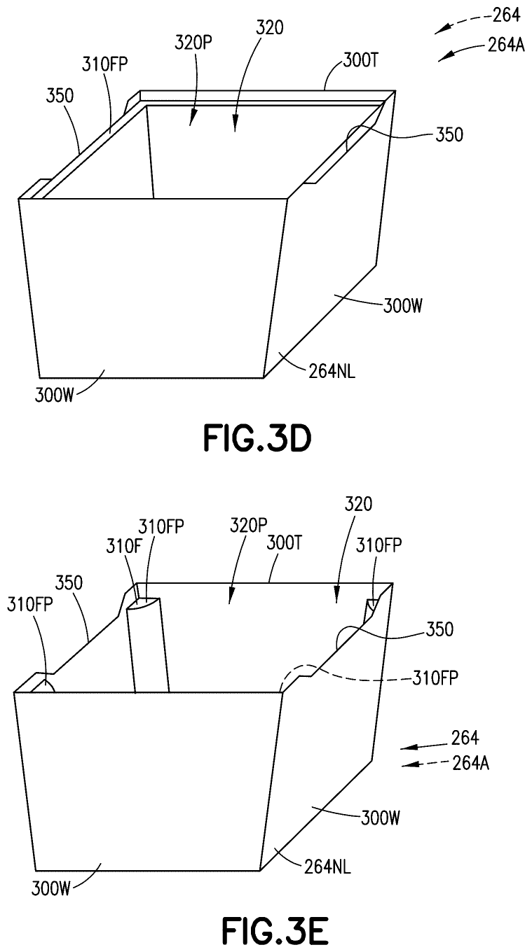

Referring to FIGS. 2A and 3A-3C, the breakpack goods container 264 has a tote casement 300 of a general frustum shape with walls 300W forming a void 320 in the tote casement 300. A top 300T of the tote casement 300 surrounding the void 320 has an upper rim 310. The upper rim 310 bounds an opening 320P of the void 320.

The upper rim 310 has a flat surface 310F for contacting and supporting another breakpack goods container 264A (see FIG. 2B) received by automation, such as the palletizer 160PB. The flat surface 310F may be disposed at a depth FSD of about 1 inch (about 25 mm) from the top 300T although, the depth FSD may be greater or less than about 1 inch.

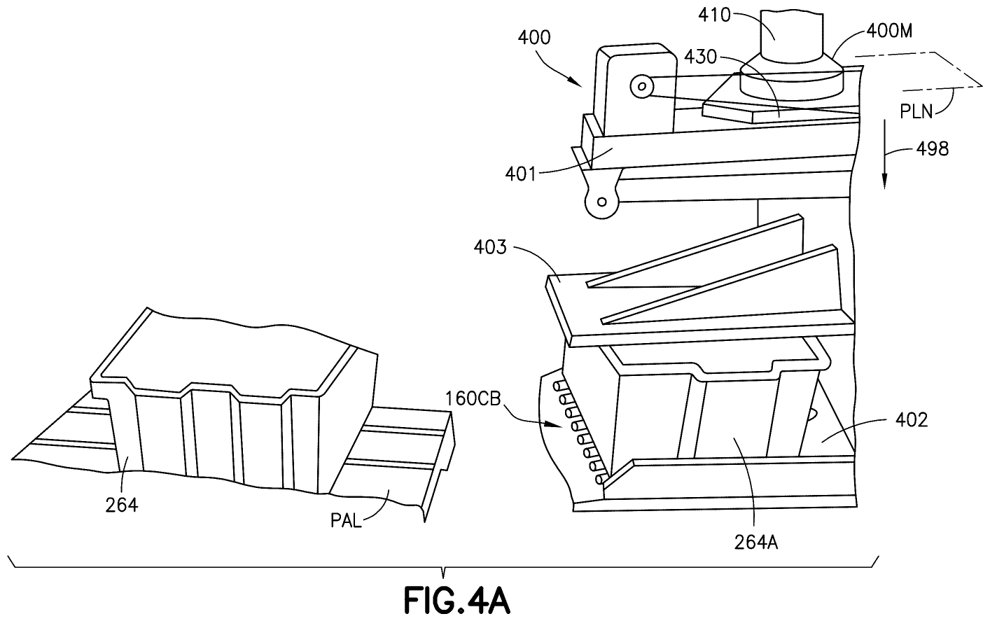

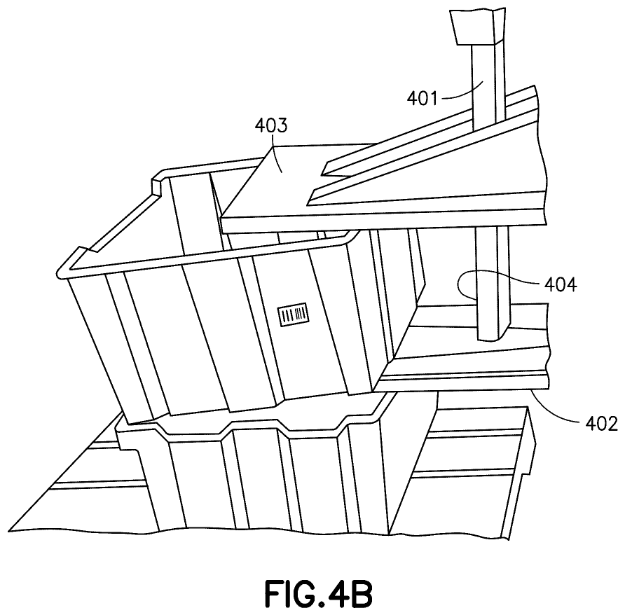

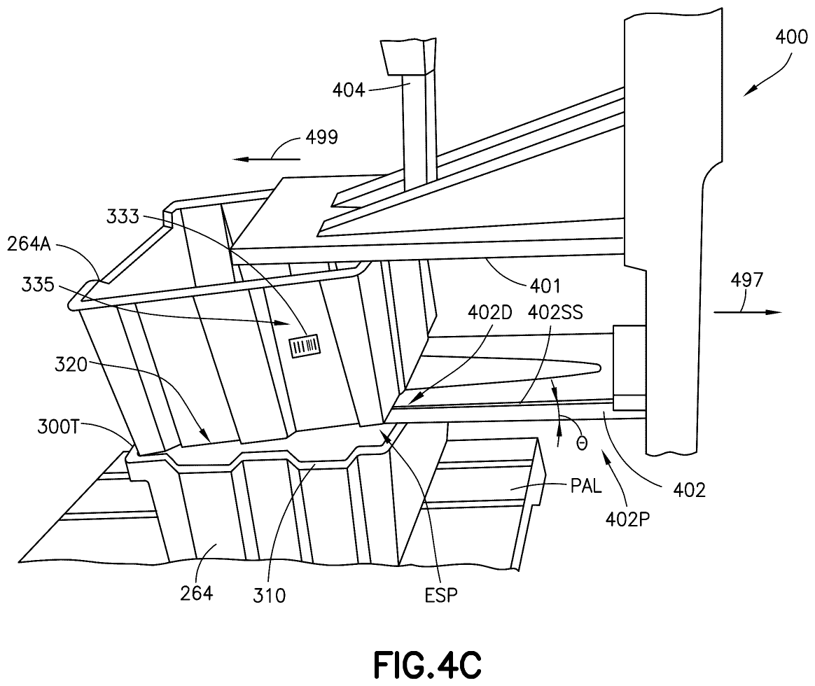

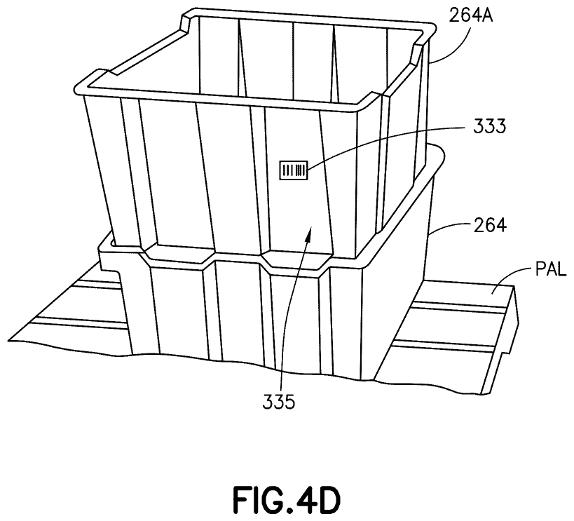

A relief channel 350 is formed in the upper rim 310. The relief channel 350 forms an escapement space ESP for an end of arm tool 400 (see FIG. 4A) of a robot 410 (such as of the palletizer 160PB) automatically stacking the other breakpack goods container 264A with (or on) the breakpack good container 264 to form a stack 290-293 (see FIG. 2A) with the standard height PH on the standard pallet PAL. The other breakpack goods container 264A may be substantially similar to or the same as the breakpack goods container 264.

The relief channel 350 and the flat surface 310F are spatially disposed relative to one another to, at least in part, substantially prevent a dropping of the other breakpack goods container 264, by the end of arm tool 400, onto the flat surface 310F, where the escapement space ESP is configured to (via the spatial relationship between the relief channel 350 and flat surface 310F) substantially prevent a dropping of the other breakpack goods container 264A, by the end of arm tool 400, onto the flat surface 310F.

For exemplary purposes only, the breakpack good container 264 may have a height TH of about 13 inches (about 330 mm), a width TW of about 20 inches (about 510 mm), and a length of about 24 inches (about 610 mm) although, the breakpack good container 264 may have any suitable height, width, and length.

The relief channel 350 is formed on the long sides (along the length) of the breakpack goods container 264 so as to be substantially centered along the length. The relief channel 350 has a length RCL of about 16 inches (about 406 mm) and a depth RCD from the top 300T of about 1 inch (about 25 mm) although, the relief channel 350 may have any suitable length and depth to form the escapement space ESP. The depth RCD of the relief channel 350 may be substantially the same as or greater than the depth FSD of the flat surface 310F so as to substantially, at least in part, eliminate a dropping of the other breakpack goods container 264A onto the flat surface 310F by the end of arm tool 400. While the relief channel 350 is illustrated as being formed only on the long sides of the breakpack goods container 264, a relief channel (similar to that described herein) may be formed on the short side (along the width) of the breakpack goods container 264.

The flat surface 310F may one or more of: circumscribe the void 320 (see FIG. 3D) so as to contact and support a periphery of a bottom side of the other breakpack goods container 264A; and include multiple discrete flat surface portions 310FP disposed at respective corners of the void 320 (see FIG. 3E) so as to support corners of the bottom side of the other breakpack goods container 264A.

The upper rim 310 may include a chamfer or flair 377 for guiding placement of the other breakpack goods container 264A into the void 320 of the breakpack goods container 264 for seating on the flat surface 310F (e.g., to nest the other breakpack goods container 264A within the breakpack goods container 264). The chamfer 377 may have any suitable dimensions (CH, CD). For example, the chamfer 377 may be a 45° chamfer with the dimensions CH, CD being about one-half of an inch (about 13 mm) although, the chamfer may have any suitable angle and dimensions. With the chamfer 377, a stacking engagement STE (see FIG. 2A) provided by the upper rim 310 between the stacked breakpack goods containers 264, 264A is at least about one-half of an inch although, the stacking engagement may be less than or greater than about one-half of an inch. Here, the upper rim 310 is configured to engage the other breakpack goods container 264A so as to constrain planar movement (see FIG. 2A) of the other breakpack goods container 264A relative to the breakpack goods container 264.

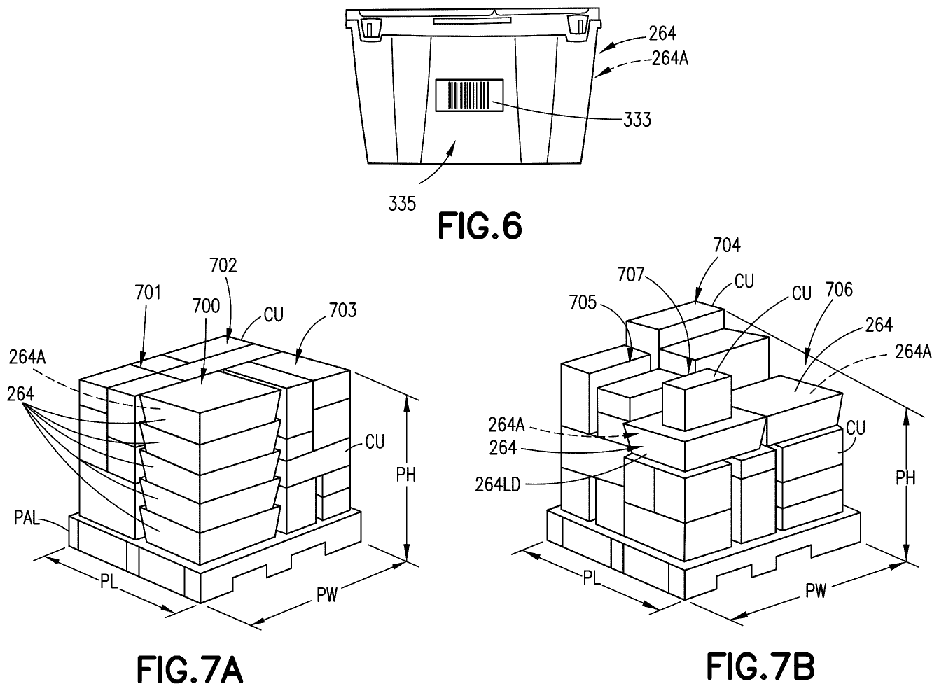

The breakpack goods container 264 may include identifying indicia 333 disposed on one or more of the walls 300W. The indicia 333 may be disposed in a recess 335 of the one or more walls 300W where the recess may protect the indicia 333 (see FIGS. 2C, 4C, 4D, and 6). The indicia 333 may be any suitable indicia that provides for identification of a respective breakpack goods container 264 to, for example, track a location of the breakpack goods container 264 within the storage and retrieval system 100, track which breakpack goods BPG are disposed within the breakpack goods container 264, track which pallet load LPAL the breakpack goods container 264 is a part of, or for any other suitable purpose. Examples of indicia 333 include, but are not limited to, bar codes, quick response (QR) codes, Data Matrix codes, international article numbers (EAN), universal product codes (UPC), Code 128, Code 39 or any other suitable indicia.

The breakpack goods containers 264, 264A illustrated in FIGS. 2B, 3A-3E are illustrated for, exemplary purposes, as lidless totes 264NL. The lidless totes may include one or more drain holes 339 disposed on a bottom and/or side walls 300W so as to provide drainage of fluid and/or debris from the void 320. As an example, the drain holes 339 may be provided on the side walls 300W at any suitable distance from the bottom, such as about one-half of an inch (the distance may be more or less than one-half of an inch) so that leaks of liquid from product/goods within the breakpack goods container 264, 264A are substantially contained within the breakpack goods container 264, 264A. The drain holes 339 may provide for drainage of water, such as from fire suppression sprinklers or rain. The drain holes 339 may provide venting of an interior of the breakpack goods containers 264, 264A during separation/de-nesting of nested breakpack goods containers 264, 264A (nesting of the breakpack goods containers is where one breakpack goods container is at least partially inserted into another breakpack goods container).

Referring also to FIGS. 2C, 2D, and 2E, the breakpack goods containers 264, 264A may be provided as lidded totes 264LD. The lidded totes 264LD may be substantially similar to the lidless totes 264NL but for a lid 299. The lid 299 may close the opening 320P of the void 320, although the lid 299 may seal the opening 320P of the void 320 such as where the lidded tote 264LD does not include drain holes 339 so as to provide a sealed container.

For example, referring to FIG. 2E, the lid 299 may be configured as a flat top lid 299F that at least partially closes the opening 320P of the breakpack goods container 264, 264A. The flat top lid 299F may be coupled to the tote casement 300 of the breakpack goods container 264, 264A in any suitable manner such as by, but not limited to, snaps, clips, latches, ties, and/or any other suitable releasable coupling(s). The flat top lid 299F of the lidded container 264LD is configured as a structural member on which the other suitable shipping containers CU (see FIG. 7B) or other breakpack goods containers 264, 264A may be stacked. The breakpack goods container 264, 264A with the flat top lid 299F may be considered, by the control server 120 (and/or warehouse management system 2500) to be the same as a suitable shipping container (rather than an open top tote) for purposes of planning a pallet load build.

The lidded tote 264LD with the flat top lid 299F may be configured to contain fluid and/or debris therein such that the lidded tote 264LD may fall without its contents egressing from the lidded tote 264LD. For example, the flat top lid 299F may conform to the upper rim 310 to close the opening 320P (inclusive of the relief channel 350) to seal the void 320. The containment provided by the lidded tote 264LD may be compliant with any suitable standards and/or best practices (e.g., in effect at the time of filing this paper) for battery storage, such as lithium batteries.

Referring to FIG. 2C, the lidded totes 264LD may include a lower casement portion 300L and an upper casement portion or lid 299C, where the lid 299 and lower casement portion 300L form the tote casement 300. The relief channel 350, chamfer 377, and flat surface 310F are incorporated into the lid 299C, where with the lid 299C coupled to the casement 300 the lidded tote 264LD has dimensions and features substantially similar to the lidless totes 264NL so that the lidded totes 264LD and lidless totes 264NL may be stacked one on (or nested within) the other in the manner described herein.

The lid 299C may be coupled to the lower casement portion 300L with a coupling 298 in any suitable manner such as by, but not limited to, snaps, clips, latches, ties, and/or any other suitable releasable coupling(s). The lidded tote 264LD with the lid 299C may be configured to contain fluid and/or debris therein such that the lidded tote 264LD may fall without its contents egressing from the lidded tote 264LD. The containment provided by the lidded tote 264LD may be compliant with any suitable standards and/or best practices (e.g., in effect at the time of filing this paper) for battery storage, such as lithium batteries.

While the lid 299C is illustrated in FIG. 2C as forming the tote casement 300 with the lower casement portion 300L, the lid 299 may be configured as an over-molded lid 299M so as to conform with the shape (such as an over-molding) of the breakpack goods container 264, 264A illustrated in FIG. 2B (the breakpack goods container 264, 264A being without drain holes for the lidded tote 264LD configuration). For example, FIG. 2D illustrates such an over-molded lid 299M that conforms to the features (e.g., the relief channel 350, chamfer 377, flat surface 310F, etc.) of the upper rim 310, which are sized so that corresponding features (i.e., relief channel 350L, chamfer 377L, and flat surface 310FL) of the over-molded lid 299M are sized to have the dimensions CH, and CD, the length RCL, the depth RCD, the stacking engagement STE, and depth FSD for receiving, in stack (as described herein), another breakpack goods container 264A.

The breakpack goods container 264 may contact the over-molded lid 299M and provide structural support to the over-molded lid 299M for supporting the other breakpack goods container 264A thereon.

The over-molded lid 299M may be releasably coupled to the tote casement 300 by the coupling(s) 298 in the same manner described with respect to the coupling of the lid 299 and the lower casement portion 300L. As noted above, the containment provided by the lidded tote 264LD may be compliant with any suitable standards and/or best practices (e.g., in effect at the time of filing this paper) for battery storage, such as lithium batteries. The lidded tote 264LD may be structurally configured to contain fluid and/or debris therein such that the lidded tote 264LD may fall without its contents egressing from the lidded tote 264LD.

The breakpack goods containers 264, 264A (in the lidded and/or unlidded configurations) may be constructed of any suitable material including, but not limited to, plastics, composites, metals, and alloys. The breakpack goods containers 264, 264A may be configured to withstand environmental conditions experienced with interior (such as within trailers, warehouses, etc.) or exterior (outside) transport and/or storage. For example, the breakpack goods containers 264, 264A may be configured to withstand rain and temperatures of about 125° F. or greater. The breakpack goods containers 264, 264A may be configured to hold therein any suitable load, such as a load of up to about fifty pounds or greater.

Referring to FIGS. 4A-4D as well as FIGS. 1-3D, an exemplary automatic stacking of the breakpack goods containers 264, 264A will be described. Such stacking of the breakpack goods containers 264, 264A may be effected at the output station 160UT where the palletizer 160PB includes the robot 410 with the end of arm tool 400. Suitable examples of the robot 410 and end of arm tool 400 can be found in, for example, U.S. Pat. No. 9,914,601 issued on Mar. 13, 2018 and 9,701,490 issued on Jul. 11, 2017, and in U.S. patent application number Ser. No. 17/805,318 filed on Jun. 3, 2022 (published as US 2022/0388163), the disclosures of which are incorporated herein by reference in their entireties. As an example, the end of arm tool 400 includes a frame 401, one or more forks 402, a gripper 403, and a pusher 404. The one or more forks 402 are disposed on the frame 401 so that the one or more forks 402 are placed underneath the object/container to be picked. The gripper 403 is movably coupled to the frame 401 so as to move towards and away from the one or more forks 402 for gripping and releasing the object/container supported on the one or more forks 402. The pusher 404 is movably coupled to the frame 401 and moves parallel with the one or more forks 402 so as to push the object/container along and off the forks 402 in direction 499.

Any suitable controller (such as control server 120 or a controller of the palletizer 160PB) commands movement of the robot 410 to pick (with the end of arm tool 400) a breakpack goods container 264 from, for example, the conveyor 160CB and place the breakpack goods container 264 in a predetermined location on the pallet PAL in accordance with any suitable pallet build plan. The robot 410 is commanded to pick the other breakpack goods container 264A from the conveyor 160CB. As illustrated, the one or more forks 402 are disposed underneath and support the breakpack goods container 264A while the gripper 403 moves in direction 498 to grip the breakpack goods container 264A against the one or more forks 402 (see FIG. 4A).

Each of the forks 402 has a support surface 402SS (see, at least FIG., 4C) that has a proximal end 402P and a distal end 402D so that the breakpack goods container 264A (or breakpack goods container 264) is seated (at least in part so as to be stably held) between the proximal end 402P and the distal end 402D. The support surface 402SS may have an anhedral angle θ (e.g., such as described in U.S. patent application number Ser. No. 17/805,318 filed on Jun. 3, 2022 and published as US 2022/0388163), relative to a predetermined level plane PLN (such as of a mounting surface of a robot mounting bracket 430 that is coupled to the frame 401 of the end of arm tool 400, where the mounting bracket 430 interfaces with and couples to an end of arm tool mount 400M of the robot 410). A breakpack goods container 264, 264A seated on the support surface 402SS is disposed at the anhedral angle θ at discharge from the end of arm tool 400 from the respective distal end(s) 402D of the one or more forks 402. The anhedral angle θ may provide, in part, for substantial prevention of dropping the other breakpack goods container 264A, by the end of arm tool 400, onto the flat surface 310F of the breakpack goods container 264 by providing a decreased drop height compared to forks having a container support surface substantially parallel with the surface upon which the container is placed to or picked from. In other words, the support surface 402SS inclined by the anhedral angle θ towards the predetermined level plane PLN at the distal end 402D enables positioning of the end of arm tool 400 at a container place position so that the container 264, 264A, discharged from the support surface 402SS at the distal end 402D to effect placement of the container 264, 264A onto the pallet PAL, has a minimum drop from the support surface 402SS to the pallet PAL or other suitable support surface (such as the flat surface 310F or another container). The anhedral angle θ may be about 3° so that the drop height provided by the one or more forks 402 is about three-quarters of an inch (about 19 mm) or less, although the angle θ may be more or less than 3° so as to provide for any suitable drop height. While the one or more forks 402 are described as having the anhedral angle θ, the anhedral angle θ may be effected by a tilting of the end of arm tool 400 by the robot 410, a tilting of the one or more forks 402 relative to the frame of the end of arm tool (e.g., by any suitable rotational drive), or in any other suitable manner.

The robot 410 lifts the other breakpack goods container 264A from the conveyor 160CB and transports the other breakpack goods container 264A for stacking with the breakpack goods container 264 (see FIG. 4B). With the other breakpack goods container 264A disposed above, and substantially aligned with the breakpack goods container 264, the robot 410 is commanded to stack the other breakpack goods container 264A with the breakpack goods container 264. The end of arm tool 400 is lowered by the robot 410 so that at least a portion of the other breakpack goods container 264A enters the opening 320P of the void 320. The chamfer 377 may guide insertion of the other breakpack goods container 264A into the void 320 of the breakpack goods container 264 so as to be seated on the flat surface 310F of the breakpack goods container 264. The gripper 401 may at least partially release the other breakpack goods container 264A so that the other breakpack goods container 264A may slide along the one or more forks 402 under impetus of at least the pusher 404 moving in direction 499 (e.g., the breakpack goods container 264A is discharged from the distal end 402D of the one or more forks 402) and the end of arm tool 400 moving in direction 497, to effect at least a partial seating of the other breakpack goods container 264 on the flat surface 310F of the breakpack goods container 264. With continued movement of the of the end of arm tool 400 in direction 497 and the pusher 404 in direction 499 (with the breakpack goods container 264A remaining substantially stationary), the breakpack goods container 264A is completely discharged from the distal end 402D of the one or more forks 402 and is seated on the flat surface 310F of the breakpack goods container 264.

To effect placement of the other breakpack goods container 264A on the breakpack goods container 264, the one or more forks are moved below the top 300T of the breakpack goods container 264 and into the escapement space ESP so that the other breakpack goods container 264A is, at least partially, substantially seated on the flat surface 310F substantially without a dropping of the other breakpack goods container 264A onto the flat surface 310F. The escapement space ESP provides clearance for the one or more forks 402 to exist between the bottom of the other breakpack goods container 264A and the upper rim 310 of the breakpack goods container 264 (see FIG. 4C) so that as the other breakpack goods container 264A is seated on the flat surface 310F of the breakpack goods container 264, the one or more forks 402 escape or otherwise retreat from between the breakpack goods containers 264, 264A through the escapement space ESP. With the other breakpack goods container 264A seated on the flat surface 310F of the breakpack goods container 264 in a stack, the other breakpack goods container 264A is nested within the breakpack goods container 264 (see FIG. 4D). As described herein, the depth RCD of the relief channel 350 may be substantially the same as or greater than the depth FSD of the flat surface 310F so as to, at least in part (such as with employment of the anhedral angle θ of the one or more forks 402), substantially eliminate a dropping of the other breakpack goods container 264A onto the flat surface 310F of the breakpack goods container 264 by the end of arm tool 400.

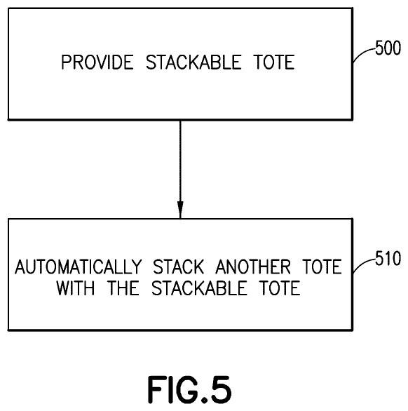

Referring to FIG. 5 and also to FIGS. 1-4D an exemplary method for stacking breakpack goods containers 264, 264A will be described. The breakpack goods container 264 (also referred to as a stackable tote) is provided (FIG. 5, Block 500). The breakpack goods container 264 has the tote casement 300 of a general frustum shape with the walls 300W forming the void 320 within the tote casement 300. The top 300T of the tote casement 300 surrounding the void 320 has an upper rim 310, bounding the opening 320P of the void 320, where the upper rim 310 has the flat surface 310F for contacting and supporting the other breakpack goods container 264A. The relief channel 350 is formed in the upper rim 310. The other breakpack goods container 264A is automatically stacked with the breakpack goods container 264 (FIG. 5, Block 510), by the end or arm tool 400 of the robot 410, so as to form the stack 290-293 with the standard height on the standard pallet PAL, where the other breakpack goods container 264A is seated on the flat surface 310F so that the flat surface 310F contacts and supports the other breakpack goods container 264A. The relief channel 350 formed in the upper rim 310 forms the escapement space ESP for the end of arm tool 400 of the robot 410 automatically stacking the other breakpack goods container 264A with the breakpack goods container 264.

The method may include any one or more of the following, in any combination with each other, and/or in any combination with the features described above: the breakpack goods container 264 includes at least one drain hole 339 for draining one or more of fluid and debris from the void 320; guiding the other breakpack goods container 264A into the void 320 of the breakpack goods container 264 with the chamfer 377 of the upper rim 310; identifying the breakpack goods container 264 with the identifying indicia 333 disposed within the recess 335 of the at least one wall 300W of the breakpack goods container 264; providing the tote casement 300 with the lower casement portion 300L and the lid 299; the lid 299 is provided with the upper rim 310 and the relief channel 350 formed therein; the lid 299 seals the opening 320P of the void 320; the relief channel 350 and the flat surface 310F are spatially disposed relative to one another to substantially prevent a dropping of the other breakpack goods container 264A, by the end of arm tool 400, onto the flat surface 310F; the escapement space ESP substantially prevents a dropping of the other breakpack goods container 264A, by the end of arm tool 400, onto the flat surface 310F; the upper rim 310 engages the other breakpack goods container 264A so as to constrain planar movement of the other breakpack goods container 264A relative to the breakpack goods container 264; and/or the stackable tote is provided with a lid.

The following are provided in accordance with the present disclosure and may be employed individually, in any combination with each other, and/or in any combination with the features described above.

In accordance with the present disclosure, a stackable tote, for an automated storage and retrieval system, comprises: a tote casement of a general frustum shape with walls forming a void within the tote casement; a top of the tote casement surrounding the void has an upper rim, bounding an opening of the void, the upper rim having a flat surface for contacting and supporting another tote received by automation; and a relief channel formed in the upper rim forming an escapement space for an end of arm tool of a robot automatically stacking the other tote with the stackable tote to form a stack with a standard height on a standard pallet.

In accordance with the present disclosure, the stackable tote one or more of: further comprises at least one drain hole; the upper rim comprises a chamfer configured to guide the other tote into the void of the stackable tote; at least one wall includes a recess with an identifying indicia disposed within the recess; the tote casement comprises a lower casement portion and a lid; the lid comprises the upper rim and the relief channel formed therein; the lid seals the opening of the void; the relief channel and the flat surface are spatially disposed relative to one another to substantially prevent a dropping of the other tote, by the end of arm tool, onto the flat surface; the escapement space is configured to substantially prevent a dropping of the other tote, by the end of arm tool, onto the flat surface; the upper rim is configured to engage the other tote so as to constrain planar movement of the other tote relative to the stackable tote; and/or further comprises a lid.

In accordance with the present disclosure, a method, for stacking totes in an automated storage and retrieval system, comprises: providing a stackable tote having: a tote casement of a general frustum shape with walls forming a void within the tote casement, a top of the tote casement surrounding the void has an upper rim, bounding an opening of the void, the upper rim having a flat surface for contacting and supporting another tote, and a relief channel formed in the upper rim; and automatically stacking, with an end of arm tool of a robot, another tote with the stackable tote so as to form a stack with a standard height on a standard pallet, where the other tote is seated on the flat surface so that the flat surface contacts and supports the other tote; wherein the relief channel formed in the upper rim forms an escapement space for the end of arm tool of the robot automatically stacking the other tote with the stackable tote.

In accordance with the present disclosure, the method one or more of: the stackable tote includes at least one drain hole for draining one or more of fluid and debris from the void; further comprises guiding the other tote into the void of the stackable tote with a chamfer of the upper rim; further comprises identifying the stackable tote with an identifying indicia disposed within a recess of at least one wall of the stackable tote; further comprises providing the tote casement with a lower casement portion and a lid; the lid is provided with the upper rim and the relief channel formed therein; the lid seals the opening of the void; the relief channel and the flat surface are spatially disposed relative to one another to substantially prevent a dropping of the other tote, by the end of arm tool, onto the flat surface; the escapement space substantially prevents a dropping of the other tote, by the end of arm tool, onto the flat surface; the upper rim engages the other tote so as to constrain planar movement of the other tote relative to the stackable tote; and/or the stackable tote is provided with a lid.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the present disclosure.

What is claimed is:

1. A stackable tote for an automated storage and retrieval system, the stackable tote comprising:
a tote casement of a general frustum shape with walls forming a void within the tote casement;
a top of the tote casement surrounding the void has an upper rim, bounding an opening of the void, the upper rim having a flat surface for contacting and supporting another tote received by automation; and
a relief channel formed in the upper rim forming an escapement space for an end of arm tool of a robot automatically stacking the other tote with the stackable tote to form a stack with a standard height on a standard pallet.

2. The stackable tote of claim 1, further comprising at least one drain hole.

3. The stackable tote of claim 1, wherein the upper rim comprises a chamfer configured to guide the other tote into the void of the stackable tote.

4. The stackable tote of claim 1, wherein at least one wall includes a recess with an identifying indicia disposed within the recess.

5. The stackable tote of claim 1, wherein the tote casement comprises a lower casement portion and a lid.

6. The stackable tote of claim 5, wherein the lid comprises the upper rim and the relief channel formed therein.

7. The stackable tote of claim 5, wherein the lid seals the opening of the void.

8. The stackable tote of claim 1, wherein the relief channel and the flat surface are spatially disposed relative to one another to substantially prevent a dropping of the other tote, by the end of arm tool, onto the flat surface.

9. The stackable tote of claim 1, wherein the escapement space is configured to substantially prevent a dropping of the other tote, by the end of arm tool, onto the flat surface.

10. The stackable tote of claim 1, wherein the upper rim is configured to engage the other tote so as to constrain planar movement of the other tote relative to the stackable tote.

11. The stackable tote of claim 1, further comprising a lid.

12. A method for stacking totes in an automated storage and retrieval system, the method comprising:
providing a stackable tote having:
a tote casement of a general frustum shape with walls forming a void within the tote casement,
a top of the tote casement surrounding the void has an upper rim, bounding an opening of the void, the upper rim having a flat surface for contacting and supporting another tote, and
a relief channel formed in the upper rim; and
automatically stacking, with an end of arm tool of a robot, another tote with the stackable tote so as to form a stack with a standard height on a standard pallet, where the other tote is seated on the flat surface so that the flat surface contacts and supports the other tote;
wherein the relief channel formed in the upper rim forms an escapement space for the end of arm tool of the robot automatically stacking the other tote with the stackable tote.

13. The method of claim 12, wherein the stackable tote includes at least one drain hole for draining one or more of fluid and debris from the void.

14. The method of claim 12, further comprising guiding the other tote into the void of the stackable tote with a chamfer of the upper rim.

15. The method of claim 12, further comprising identifying the stackable tote with an identifying indicia disposed within a recess of at least one wall of the stackable tote.

16. The method of claim 12, further comprising providing the tote casement with a lower casement portion and a lid.

17. The method of claim 16, wherein the lid is provided with the upper rim and the relief channel formed therein.

18. The method of claim 16, wherein the lid seals the opening of the void.

19. The method of claim 12, wherein the relief channel and the flat surface are spatially disposed relative to one another to substantially prevent a dropping of the other tote, by the end of arm tool, onto the flat surface.

20. The method of claim 12, wherein the escapement space substantially prevents a dropping of the other tote, by the end of arm tool, onto the flat surface.

21. The method of claim 12, wherein the upper rim engages the other tote so as to constrain planar movement of the other tote relative to the stackable tote.

22. The method of claim 12, wherein the stackable tote is provided with a lid.
